(19) United States
(12) Patent Application Publication
(10) Pub. No.: US 2016/0058148 A1
(43) Pub. Date: Mar. 3, 2016

(54) Identification Clip Patch Tag

(71) Applicant: Dale S. Krasnow, Thousand Oaks, CA (US)

(72) Inventor: Dale S. Krasnow, Thousand Oaks, CA (US)

(21) Appl. No.: 14/476,251

(22) Filed: Sep. 3, 2014

(30) Foreign Application Priority Data
Sep. 3, 2014 (US) 14476251

(51) Int. Cl. A45C 13/42; A44B 15/00; G09F 3/08; A44B 13/02

(52) U.S. Cl. CPC A45C 13/42; A44B 13/02; A44B 15/00; G09F 3/08

(57) ABSTRACT

The identification clip patch tag is used in combination of four members. The first member, patch with the second member, embedded curved press spring clip are used for embellishment and identification on a handbag, purse or apparel pocket item. The first and second members are combined with the third member, split ring inserted into the clip U-channel and fourth member, clasp inserted into the third member used on a backpack, luggage, notepad or key for easy identification. Commonly a backpack, handbag, purse, luggage or notepad case are used to carry ones belongings. Many of these belongings look similar. This can lead to an owner-user grabbing another's belongings when many similar type's, colors are grouped. The identification clip patch tag prevents a common problem when identifying baggage off the airport carousal at the airport or on a group field trip or travel setting where backpacks, handbags, purses, belongings get piled and intermingled together. Furthermore, it increases user-owner loss prevention with clear bold identification front face patch designs. The patch display feature allows the owner-user to express their support or awareness for a non-profit or for-profit cause by using the front face of the identification clip patch tag to display a message with the unique front face design. Other patches typically need to be sewed permanently in-place. This arrangement allows for quick installation and frequent Identification clip patch tag swapping of the fashionable collectable designs by using the multiple unique clip application options to display the design.

### BACKGROUND

### Prior Art

The following is a tabulation of some prior art that appears relevant:

U.S. Patents

| Pat. No. | Kind Code | Issue Date | Patentee |
|---|---|---|---|
| U.S. Pat. No. 8,418,267 | B2 | Apr. 16, 2013 | April Lee Shaw |
| U.S. Pat. No. 7,308,922 | A | Dec. 18, 2007 | Allexx, Inc. |
| U.S. Pat. No. 6,076,194 | A | Jun. 20, 2000 | Varan C. Purkett |
| U.S. Pat. No. 4,860,563 | A | Aug. 29, 1989 | Edward L. Gerch |
| UA5800900 | A | Sep. 1, 1988 | Lawrence E. |
| | | | Mitchell |

### BACKGROUND OF INVENTION

The invention pertains to a fashionable identification Clip Patch tag with a secondary function as a key chain. This invention enables one to Clip an identification patch and quickly identify owner-user belongings from others; including a backpack, luggage, handbag, purse, notepad case, keys or clothing apparel.

### BRIEF SUMMARY OF INVENTION

The identification Clip Patch tag includes four members used in sums or parts to accomplish multiple clip options to display the embroidered or plastic patch identifier. The first member is a patch embroidered material or plastic on the front face, with a twill fabric or plastic on the back face. Front face designs are fashionable and unique to provide quick easy identification and subsequent loss prevention.

The second member is a clip embedded into the first member. The second member incorporates a U-channel region with the flat portion embedded between the first member patch front face inside and the back face inside cover. This clip flat part is usually glued, but can also be riveted or screwed to stay embedded and secured within the patch. The clip curved section is external to the back face cover and functions to clip to a portion of the user-owner item between the back of the clip section and the back side of the patch. This member can be used alone or combined with other members described herein.

The first and second members are engaged to one another for clipping onto a handbag, purse, pant pocket or apparel, for maximum clip flexibility to address multiple owner-user identification and loss purposes.

A third member and fourth member are to be used together attached to the first and second member. A third and fourth member includes a split ring with a clasp that fits into the split ring and is then inserted into second member clip upper U-channel. The owner-user can than clip the patch portion to other personal items for easy identification.

The fourth member clasp is used to clip selectively to keys in the clasp end or onto owner-user property containing a zipper, strap, or handle.

The proceeding and other features of the invention will become further apparent from the detailed description that follows. Such description is accompanied by a set of drawing figures. Numerals of the drawing figures correspond to numerals of the written description with like numerals referring to like features are throughout both the written description and the drawing figures.

### BRIEF DESCRIPTION OF THE DRAWING

FIG. 1(A) is a side view of the clip portion of the identification clip patch tag exposed; referred to as the second member. At the rear of first member, the second member clip has an embedded flat portion, embedded between the front face material and back face material.

FIG. 1(B) side view, showing the split ring inserted into the clip U-channel.

FIG. 1(C) back face view (also referred to as rear), shows the third member split ring inserted at the top of the identification clip patch tag U-channel.

FIG. 1(D) front face view with unique design pattern options.

FIG. 1(E) is a back face view of the identification clip patch tag; view shows the clasp third member integrated for user flexibility.

FIG. 2(A) is a perspective view of an owner user in use identification clip patch tag with a handbag, or purse.

FIG. 2(B) is a cross section view of the inside of FIG. 2(A) and FIG. 4.

FIG. 3 is a perspective view of the owner-user in use identification clip patch tag with a backpack, luggage, notepad case, or keychain.

FIG. 4 is a perspective view of an owner-user in use with an identification clip patch tag inserted into a pant fashion pocket or apparel.

### DRAWINGS

### Reference Numbers

12 Front Face of Identification Patch and Design, first member
15 Clip, second member
16 Clip curved section
17 Clip to back face press spring fit area
18 Back face cover of first member
19 Clip U-channel
20 Clasp, fourth member
21 Location of the bond area for clip to patch permanent retention
22 Handbag, Purse front surface
23 Handbag, Purse or apparel inside view of upper lip or opening
24 Identification clip patch tag inserted into Handbag, Purse or apparel inside view.
25 Backpack, luggage or notepad cover zipper installation of the Identification clip patch tag in-use
26 Pants pocket apparel front view of the identification clip patch tag in-use.
27 Clip flat portion of second member
28 Split ring, third member
32 Handbag or Purse upper lip of opening

### DETAILED DESCRIPTION OF THE INVENTION

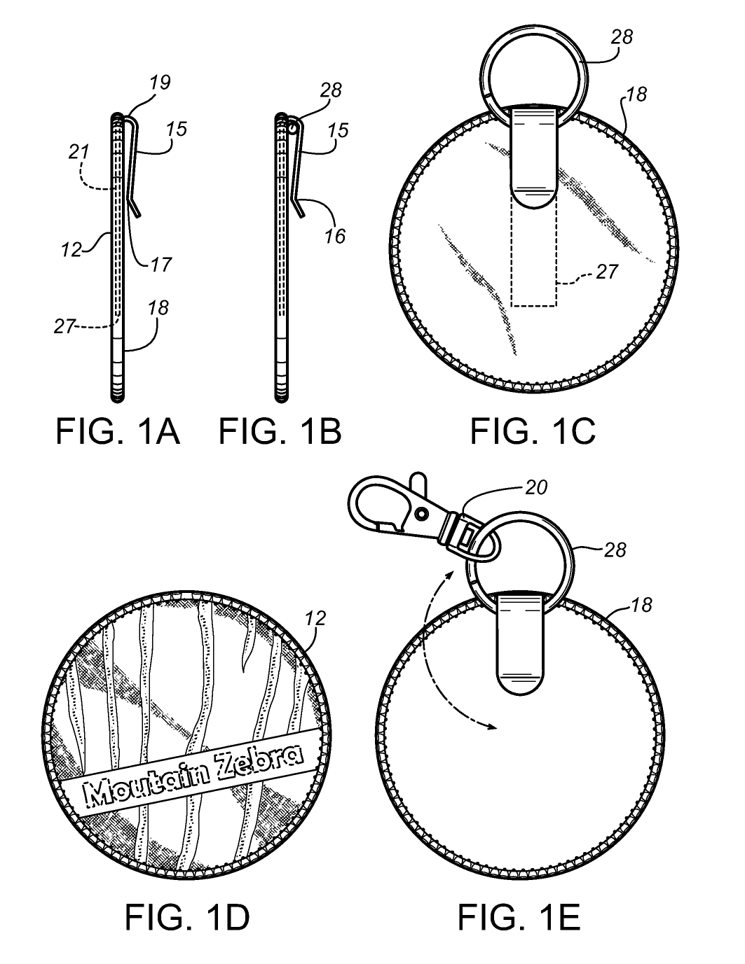

Referring to the drawings, FIG. 1(A) is a side view of the identification clip patch tag 12 of the invention. The identification clip patch tag 12 comprises of the first member identification patch 12 and second member Clip 15. 12 is preferably made of embroidered polyester, fabric or plastic material, 15 preferably of steel or other metal alloy or plastic or other rigid spring type material may be employed.

The second member 15 has a flat portion 27 that is embedded through a slot at top of the rear face 18 of first member. The bond 21 adhering second member 27 into the first member is glue, hot melt, rivets or screwed in.

The front face of the first member 12 provides a fashionable design or message for easy identification. This message may support various causes involving non-profit or for profit. This may be embroidered, printed or plastic. The backside face 18 may be twill, polyester or plastic.

The back face 18 of member 1 is used for support and coverage of the flat part of second member 27 and may display printing complementing the front design.

The second member clip 15 has an integrated curve 16 to apply a press spring fit to secure at 17 the owner-user item for easy identification. The second member 15 includes a U-channel 19 that the third member 28 is inserted through.

The third member 28 is free to pivot 180 degrees up or down while inserted in the U-channel 19 at the top of 15 as shown in FIG. 1(B). FIG. 1(C) is a visual of the third member inserted into the second member as viewed pivoted in the up position.

FIG. 1(D) shows the identification clip patch tag only for insertion press spring fit 17 clip onto any material including clothing apparel, purse or handbag to achieve identification and a new look as expressed by the identification clip patch tag from the front face design.

FIG. 1(E) forth member includes the clasp 20 inserted into third member 28 pivoted to the up position from within the second member U-channel 19. This can be used in the key chain configuration or used to clip it to owner-user property for easy identification. The arrows show the in use key chain configuration pivoted 180 degrees in the downward or upward position.

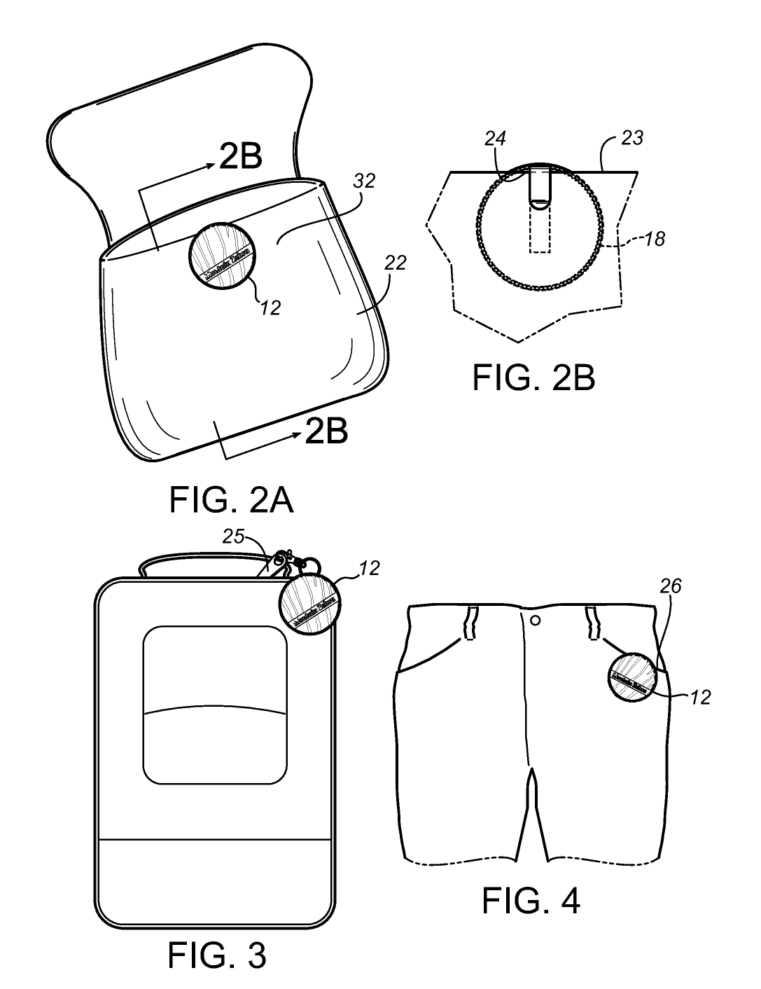

FIG. 2(A, B,) and FIG. 3 are perspective views of the identification clip patch tag 12 of the invention in use. In FIG. 2A) the identification clip patch tag is hung over the edge 32 from the integrated clip U-channel region 19 overhanging the outside area 22 so that the identification clip patch tag font face design is exposed. This provides the owner-user with easy identification of clipped article along with an attractive fashion addition unique front face design.

FIG. 2(B) is the invention inside view in use using first and second member to achieve an installation on a handbag or purse 22, pant pocket or apparel 26 of the identification clip patch tag.

FIG. 3 is an invention in use on a zipper 25 for luggage, backpack or notepad cover to display 12, a unique design front face for easy identification and fashion complement. This application uses all material elements.

1-3. (canceled)

4. An apparatus identification clip patch tag for easy identification and subsequent loss prevention of personal items.
wherein the identifying displayed member is mounted to an embedded clip part and herein retains various other members for flexible identification by attaching to multiple personal items.
wherein The embodiments are comprising separately or in combination of the following;

[symbol]

5. The apparatus of claim 4, wherein the embroidered, twill or plastic patch first member, patch comprising of a front face with a unique identification design with said rear face comprising of a cover with a slot; and

[symbol]

6. The apparatus of claim 4, wherein second member clip flat portion is embedded through a slot between the front and rear patch face; wherein

[symbol]

7. The apparatus of claim 4, wherein second member clip and first member back face are opposed to each other providing the ability to clip onto a handbag, purse, backpack, notepad, or clothing pocket or apparel.

8. The apparatus of claim 4, wherein a said identification clip patch tag on the front face is configured to allow to hang by the press spring fit area of clip from the edge of an article it is attached to.

9. The apparatus of claim 4, wherein said identification clip patch tag shape is generally round, square, rectangle or triangular.

10. The apparatus of claim 4, wherein a third member split ring installed onto the second member U-channel of the embedded clip enabling the ring to rotate 180 degrees up and down; and

[symbol]

11. The apparatus of claim 4, wherein a fourth member clasp inserted in the split ring to retain a least one key and provide maximum user-owner clip options onto zippered, strap or handle of personal items for identification and display; wherein

[symbol]

12. The apparatus of claim 4, wherein said clasp inserted in split ring is rotatable, but fixed onto the ring.

13. The apparatus of claim 4, wherein said front face identification design is displayed typically embroidered, printed or plastic.

14. The apparatus of claim 4, wherein, wherein said back face design is typically twill, polyester or plastic.

15. The apparatus of claim 4, a four-member apparatus configured identification clip patch tag integrating;

[symbol]

16. The apparatus of claim 15, said patch comprising of a front face with a unique identification design display; and

[symbol]

17. The apparatus of claim 15, said rear face comprising of a cover with a slot opening; and

[symbol]

18. The apparatus of claim 15, said internal front and rear face forming an embedded cavity area to retain directly and permanently affixing the second member flat metal alloy or plastic portion for the clip; and

[symbol]

19. The apparatus of claim 15, said third member that comprises of a split metal ring working in conjunction of a fourth member closed-form clasp; and

[symbol]

20. The apparatus of claim 15, said split ring is inserted into the second member U-channel clip for retention and rotation of 180 degrees.

21. The apparatus of claim 15, where said split metal ring is replaced by a carabiner type spring hook.

22. A method to retain the patch first member to the clip second member comprising;

[symbol]

23. The apparatus of claim 22, a method wherein said second member flat portion of the clip is inserted into the patch identification first member embedded area through a slot at the rear face.

24. The apparatus of claim 22, a method wherein said second member flat portion of the clip is secured permanently within the embedded area of first member by glue, rivet, fastener or screw.

25. The apparatus of claim 22, a method wherein an identification clip patch tag, in combination of a patch identification first member having front face and rear face forming an internal cavity embedded area; wherein

[symbol]

26. The apparatus of claim 22, a method wherein a flat end of the clip is embedded within the cavity formed by the inside patch front face and rear face cover to permanently retain the clip.

27. The apparatus of claim 22, a method wherein a third member split ring that inserts into the clip U-channel with attached fourth member clasp of the second member clip to extend the application as a key ring to hold one or more keys.

28. The apparatus of claim 4, an identification and loss prevention method comprising;

[symbol]

29. The apparatus of claim 28, a method wherein identifying ones property among similar items as an identification clip patch tag displayed outward, attached or hanging on said apparatus to identify owner-user belongings from others; including a backpack, luggage, handbag, purse, notepad case, keys or clothing. Wherein;

[symbol]

30. The apparatus of claim 28, a method wherein said identification clip patch tag is engaged onto a user-owner material that is inserted between the curved pressed spring fit clip and flat back face cover of patch securing for identification, and subsequent loss prevention.

31. The apparatus of claim 28, a method wherein said identification clip patch tag is engaged using the clasp attached to the split ring, inserted into the U-channel of the patch embedded clip; where by clipped to a zipper or strapped owner-user property.

32. The apparatus of claim 28, a method wherein said identification clip patch tag is engaged using the clasp attached to the split ring, inserted into the U-channel of the patch embedded clip; where by clipped to a key.

33. The apparatus of claim 28, a method wherein said attaching the patch apparatus retained by inside of the second member said clip U-channel clip curved pressed spring fit allows the patch front face to be displayed overhanging the side panel for identification on a handbag, purse, backpack, luggage, notepad case or apparel pocket.

34. The apparatus of claim 28, a method wherein said identification clip patch tag is engaged using the clasp attached to the split ring, inserted into the U-channel of the patch embedded clip; where by clipped to a zipper or strapped owner-user property for easy identification.

35. The apparatus of claim 28, a method wherein attaching the patch apparatus retained by fourth member said clasp of the third member clip split ring allows for the patch front face to be displayed hanging and retained for identification of at least one key, or any item having a zipper, strap or handle.
